(19) United States
(12) Patent Application Publication
(10) Pub. No.: US 2025/0246181 A1
(43) Pub. Date: Jul. 31, 2025

(54) Audio-Adapter Fusion for Efficient and Non-Destructive Multi- Task Speech Recognition

(71) Applicant: Google LLC, Mountain View, CA (US)

(72) Inventors: Hillary Lik-Huang Ngai, San Francisco, CA (US); Neeraj Gaur, Jersey City, NJ (US); Parisa Haghani, Atlanta, GA (US); Pedro J. Moreno Mengibar, Jersey City, NJ (US); Wenqian Ronny Huang, Princeton Junction, NJ (US); Rohan Agrawal, Brooklyn, NY (US)

(73) Assignee: Google LLC, Mountain View, CA (US)

(21) Appl. No.: 19/034,440

(22) Filed: Jan. 22, 2025

Related U.S. Application Data
(60) Provisional application No. 63/626,272, filed on Jan. 29, 2024.

(51) Int. Cl. G10L 15/065; G10L 15/06; G10L 15/32; G10L 25/30

(52) U.S. Cl. CPC G10L 15/065; G10L 15/063; G10L 15/32; G10L 25/30

(57) ABSTRACT

A method includes obtaining an audio encoder pre-trained on an initial training data set. The audio encoder includes a plurality of multi-head attention layers. The method also includes obtaining a first adapter corresponding to a first task and obtaining a second adapter corresponding to a second task. The operations also include adapting the audio encoder for the first task and the second task by inserting, in parallel, the first adapter and the second adapter at one or more of the plurality of multi-head attention layers of the audio encoder.

### CROSS-REFERENCE TO RELATED APPLICATIONS

This U.S. patent application claims priority under 35 U.S.C. § 119 (e) to U.S. Provisional Application 63/626,272, filed on Jan. 29, 2024. The disclosure of this prior application is considered part of the disclosure of this application and is hereby incorporated by reference in its entirety.

### TECHNICAL FIELD

This disclosure relates to Audio-Adapter Fusion for efficient and non-destructive multi-task speech recognition.

### BACKGROUND

Automatic speech recognition (ASR) is a category of natural language processing (NLP) which involves processing audio containing human speech. An ASR model (or speech model) is often used to recognize and/or translate spoken language into text. One way to produce an ASR model is by using machine learning to train a model on large sets of data. Due to the amount of data that is used for training and the amount of time the training takes, ASR models are usually generalized for many domains and users, which make the models inflexible. Attempts to make ASR models more flexible, such as by using a number of smaller models, can be computationally expensive (e.g., through redundancies in training the multiple models) or provide skewed results (e.g., models with less training data will not be as robust). Further, fine-tuning a large pre-trained model to a specific task is neither practical nor scalable to multiple tasks.

### SUMMARY

One aspect of the disclosure provides a computer-implemented method executing on data processing hardware that causes the data processing hardware to perform operations that include obtaining an audio encoder pre-trained on an initial training data set. The audio encoder includes a plurality of multi-head attention layers. The operations also include obtaining a first adapter corresponding to a first task, obtaining a second adapter corresponding to a second task, and adapting the audio encoder for the first task and the second task by inserting, in parallel, the first adapter and the second adapter at one or more of the plurality of multi-head attention layers of the audio encoder.

Implementations of the disclosure may include one or more of the following optional features. In some implementations, the first adapter is pre-trained on a first task training data set corresponding to the first task and the second adapter is pre-trained on a second task training data set corresponding to the second task. The operations may further include obtaining a fusion training data set and training the first adapter and the second adapter based on the fusion training data set. Here, training the first adapter and the second adapter based on the fusion training data set may include tuning a plurality of fusion parameters added to the plurality of multi-head attention layers of the audio encoder Tuning the plurality of fusion parameters may include obtaining a recurrent neural network-transducer (RNN-T) loss and tuning, based on the RNN-T loss, the plurality of fusion parameters. The parameters of the first adapter and the second adapter may be frozen while tuning the plurality of fusion parameters.

In some examples, the operations further include: obtaining, based on an input, a first output from the first adapter; obtaining, based on the input, a second output from the second adapter; and aggregating the first output and the second output. In these examples, the operations may further include obtaining an encoded representation output from the audio encoder based on the input and combining the encoded representation with the aggregated first and second outputs.

The initial training data set may include a set of un-transcribed speech utterances. Here, the audio encoder may be pre-trained on the set of un-transcribed speech utterances using Bidirectional Encoder Representations from Transformers (BERT)-based speech pre-training with random projection quantizer (BEST-RQ). The plurality of multi-head attention layers of the audio encoder may include a plurality of Conformer layers.

Another aspect of the disclosure provides a system for training a hotword detector using two labels for training data and two loss functions. The system includes data processing hardware and memory hardware in communication with the data processing hardware. The memory hardware stores instructions that when executed on the data processing hardware causes the data processing hardware to perform operations including obtaining an audio encoder pre-trained on an initial training data set. The audio encoder includes a plurality of multi-bead attention layers. The operations also include obtaining a first adapter corresponding to a first task, obtaining a second adapter corresponding to a second task, and adapting the audio encoder for the first task and the second task by inserting, in parallel, the first adapter and the second adapter at one or more of the plurality of multi-head attention layers of the audio encoder.

This aspect may include one or more of the following optional features. In some implementations, the first adapter is pre-trained on a first task training data set corresponding to the first task and the second adapter is pre-trained on a second task training data set corresponding to the second task. The operations may further include obtaining a fusion training data set and training the first adapter and the second adapter based on the fusion training data set. Here, training the first adapter and the second adapter based on the fusion training data set may include tuning a plurality of fusion parameters added to the plurality of multi-head attention layers of the audio encoder. Tuning the plurality of fusion parameters may include obtaining a recurrent neural network-transducer (RNN-T) loss and tuning, based on the RNN-T loss, the plurality of fusion parameters. The parameters of the first adapter and the second adapter may be frozen while tuning the plurality of fusion parameters.

In some examples, the operations further include: obtaining, based on an input, a first output from the first adapter; obtaining, based on the input, a second output from the second adapter; and aggregating the first output and the second output. In these examples, the operations may further include obtaining an encoded representation output from the audio encoder based on the input and combining the encoded representation with the aggregated first and second outputs.

The initial training data set may include a set of un-transcribed speech utterances. Here, the audio encoder may be pre-trained on the set of un-transcribed speech utterances using Bidirectional Encoder Representations from Transformers (BERT)-based speech pre-training with random projection quantizer (BEST-RQ). The plurality of multi-head attention layers of the audio encoder may include a plurality of Conformer layers.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1 is a schematic view of an example system for implementing Audio-Adapter Fusion for efficient and non-destructive multi-task speech recognition.

FIG. 2 is a schematic view of an example automatic speech recognition (ASR) model.

FIG. 3 is a schematic view of an example training process for pre-training an audio encoder having a plurality of multi-head attention layers.

FIG. 4 is a schematic view of an example Conformer architecture of an audio encoder.

FIG. 5 is a schematic view of an example audio adapter model.

FIG. 6A is a schematic view of an example Audio-AdapterFusion architecture for an audio encoder.

FIG. 6B is a schematic view of another example Audio-AdapterFusion architecture for an audio encoder.

FIG. 7 is a schematic view of an example training process for an Audio-AdapterFusion model.

FIG. 8 a flowchart of an example arrangement of operations for a method of adapting an audio encoder for efficient and non-destructive multi-task speech recognition.

FIG. 9 is a schematic view of an example computing device that may be used to implement the systems and methods described herein.

Like reference symbols in the various drawings indicate like elements.

### DETAILED DESCRIPTION

Automatic speech recognition (ASR) is a growing field of language processing which has a wide variety of uses, from automatic translation and transcription of speech to processing voice commands for computing devices. Recently, neural networks for machine learning have been found to perform well as a base for ASR systems and models. Using machine learning techniques, ASR models may be trained on large sets of training data including audio samples of speech to produce a robust model for speech recognition. Generally, these ASR models are large, as the more extensively the model is trained, the better it performs. However, there are drawbacks to using such large models, such as a single model used for a wide variety of users with different characteristics. For example, a single ASR model may be built for the English language even though English speakers can have many different accents or colloquialisms based on local and region. In turn, the ASR model may not perform as accurately for certain groups of users. Further, it is difficult to retrain or update models due to the computational expenses. This may cause the ASR model to be out of date and not perform well for new/emerging words/phrases (e.g., slang, new TV shows).

The most commonly used method for tuning an Automatic Speech Recognition (ASR) system for a single task/domain is to perform transfer learning. Typically, a state-of-the-art ASR model, such as the recurrent neural network-transducer (RNN-T) architecture having encoder Conformer layers, is pre-trained on a source task with semi-supervised learning. The pre-trained model is then adapted to the target task by fine-tuning all of its weights on this single task. While this approach can achieve impressive results on one task, fine-tuning the entire ASR model per task is computationally expensive and does not scale well when there are many tasks. A number of other methods, such as sequential fine-tuning and multi-task learning (MTL), are aimed at fine-tuning large ASR models. However, these other methods have drawbacks such as catastrophic forgetting (sequential fine-tuning) and inflexibility (MTL).

Recently, residual adapters have emerged as an efficient alternative to full fine-tuning of pre-trained ASR models. Adapters were initially proposed for language modeling but have also shown success in ASR. Due to its parameter-efficiency and modularity, adapters are particularly useful to scale the training and serving of large ASR models to many tasks. Here, instead of fine-tuning the entire ASR model for each task, a single-task adapter (including a relatively small number of randomly-initialized parameters) is introduced at every Conformer encoder layer for each task. While freezing the weights of the shared pre-trained model, single-task adapters are trained separately for respective tasks. Despite only training a few additional parameters per task, adapters have been shown to perform on-par with full fine-tuning. In production settings, a task ID is commonly prepended to each input during inference to route to the adapters trained on that specified task. However, one major limitation of this approach is that the task ID is typically unknown during inference time. Moreover, this approach restricts the knowledge sharing between adapters trained on different tasks, thereby impeding the ASR model's potential for enhancing generalizability. Thus, using a task ID is not practical for most multi-task settings, thereby lowering the conventional applicability of adapters.

Implementations herein are related to leveraging AdapterFusion to address many of the issues in language modeling. AdapterFusion is a task-ID-free method that leverages knowledge from different single-task adapters to solve multiple tasks, without suffering from the same problems as sequential fine-tuning and MTL. There are two stages in AdapterFusion, the knowledge extraction stage and the knowledge composition stage. In the knowledge extraction stage, single-task adapters are trained separately on multiple tasks. In the knowledge composition stage, adapters trained on various tasks are combined to share information across tasks.

The present disclosure is aimed at implementing AdapterFusion to build a multi-task capable ASR model. Audio-AdapterFusion (A-AF) combines parallel adapters trained on different tasks in an efficient and non-destructive manner to solve multiple ASR tasks. A-AF is a task-ID-free method which outperforms full fine-tuning and is on par with using a task ID to route to adapters trained on the specified task.

Unlike AdapterFusion, which implements sequential adapters, A-AF combines parallel adapters at each Multi-head Attention and/or Conformer encoder layer (rather than BERT layer) and adds Layer Normalization (LayerNorm) before the residual layer. In some implementations, training the adapters includes updating and sharing weights for the adapters (i.e., knowledge composition stage), where each adapter is first pre-trained based on a specific task (knowledge extraction stage). In other implementations, the adapters are pre-trained and parameters are not shared between adapters.

The present disclosure provides the advantage of multi-task adaptation of an ASR model. Instead of having N large ASR models for N tasks, implementations disclosed herein provide one large base model integrated with a set of N single-task adapters, which may be combined using Audio-AdapterFusion. In other words, the present disclosure provides architectures and techniques for solving multiple tasks (e.g. long-form audio, short-form audio, atypical speech, alphanumeric speech, etc.) with one large model (e.g., pre-trained audio encoder) rather than having separate large models for each task. Further, implementations herein do not require a task ID for multi-task adaptation. By not requiring a task ID, the A-AF model of the current disclosure is more capable of handling traffic that is mixed in terms of tasks or domains (e.g. French vs. English or long-form audio vs. short-form audio).

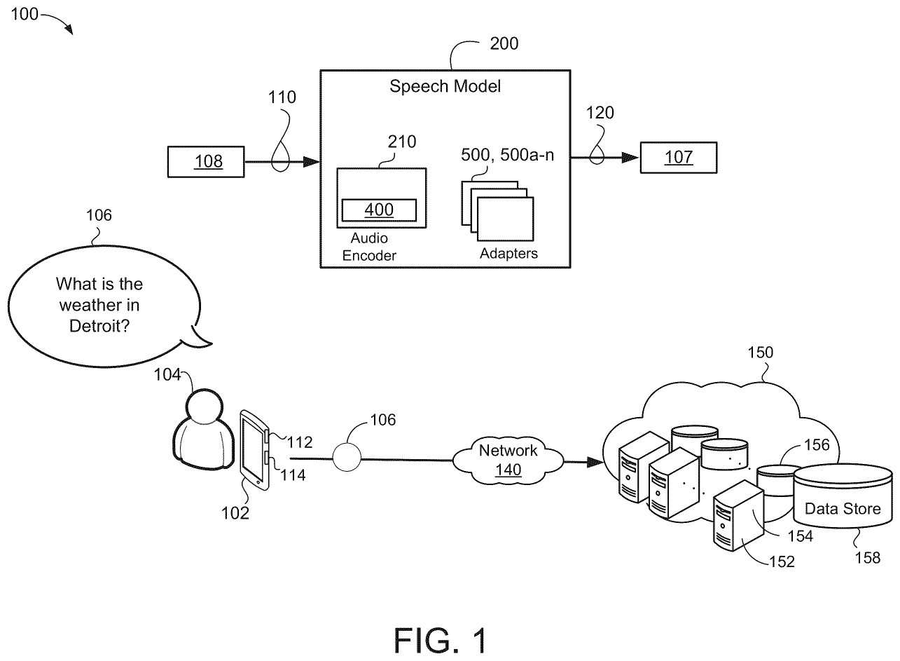

FIG. 1 illustrates an example system 100 including a user 104 communicating a spoken utterance 106 to a speech-enabled user device 102 (also referred to herein as a device 102 or a user device 102) in a speech environment. The system 100 implements an speech model 200 that resides on the user device 102 of the user 104 and/or on a remote computing system 150 (e.g., one or more servers of a distributed system executing in a cloud environment) in communication with the user device 102 through a network 140. Some examples of user devices 102 include, but are not limited to, mobile devices (e.g., mobile phones, tablets, laptops, etc.), computers, wearable devices (e.g., smart watches, smart goggles, smart glasses, etc.), smart appliances, internet of things (IoT) devices, vehicle infotainment systems, smart speakers, smart assistant devices, etc. The user device 102 includes data processing hardware 112 and memory hardware 114 in communication with the data processing hardware 112 and storing instructions, that when executed by the data processing hardware 112, cause the data processing hardware 112 to perform one or more operations. Examples herein refer to the speech model 200 as an automated speech recognition (ASR) model, however, the speech model 200 may include other types of speech models such as an automatic speech translation (AST) model, speech-to-speech model, or any other type of speech model without departing from the scope of the present disclosure.

The user device 102 includes an audio subsystem 108 configured to receive the utterance 106 spoken by the user 104 (e.g., the user device 102 may include one or more microphones for recording the spoken utterance 106) and convert the utterance 106 into a corresponding digital format associated with input acoustic frames 110 capable of being processed by the ASR model 200. While the device 102 implements a single audio subsystem 108 in the example shown, the device 102 may implement an array of audio subsystems 108 without departing from the scope of the present disclosure, whereby one or more audio subsystems 108 in the array may not physically reside on the device 102, but be in communication with the audio subsystem 108. For example, the device 102 may correspond to a vehicle infotainment system that leverages an array of microphones positioned throughout the vehicle. In the example shown, the user speaks a respective utterance 106 in a natural language of English for the phrase “What is the weather in Detroit?” and the audio subsystem 108 converts the utterance 106 into corresponding acoustic frames 110 for input to the ASR model 200. Thereafter, the ASR model 200 receives, as input, the acoustic frames 110 corresponding to the utterance 106, and generates/predicts, as output, a corresponding transcription 120 (e.g., recognition result/hypothesis) of the utterance 106.

In the example shown, the user device 102 and/or the remote computing system 150 also executes a user interface generator 107 configured to present a representation of the transcription 120 of the utterance 106 to the user 104 of the user device 102. In some configurations, the transcription 120 output from the ASR model 200 is processed, e.g., by a natural language understanding (NLU) module executing on the user device 102 or the remote computing system 150, to execute a user command. Additionally or alternatively, a text-to-speech (TTS) system (e.g., executing on any combination of the user device 102 or the remote computing system 150) may convert the transcription into synthesized speech for audible output by another device. For instance, the original utterance 106 may correspond to a message the user 104 is sending to a friend in which the transcription 120 is converted to synthesized speech for audible output to the friend to listen to the message conveyed in the original utterance 106.

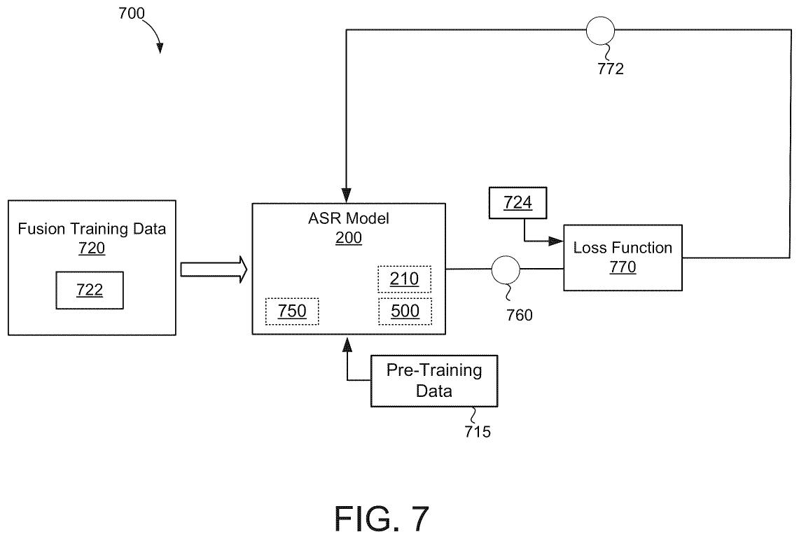

The remote computing system 150 (i.e., also referred to herein as a cloud computing environment) may be a single computer, multiple computers, or a distributed system having scalable/elastic resources 152 including computing resources 154 (e.g, data processing hardware) and/or storage resources 156 (e.g., memory hardware). A data store 158 (i.e., a remote storage device) may be overlain on the storage resources 156 to allow scalable use of the storage resources 156 by one or more user devices 102 or the computing resources 154. The device 102 may utilize the remote resources 152 to perform various functionality related to ASR. For instance, the device 102 may be configured to perform speech recognition using the ASR model 200. The ASR model 200 may reside on the device 102 (referred to as on-device systems) or reside remotely (e.g., reside on the remote system 150), but in communication with the device 102. In other words, the ASR model 200 may be local, remote, or both in any combination. For instance, when the ASR model 200 is rather large in size or processing requirements, the ASR model 200 may reside in the remote system 150. Yet, when the device 102 may support the size or the processing requirements of the ASR model 200, the model 200 may reside on the device 102 using the data processing hardware 112 and/or the memory hardware 114. In some implementations, the ASR model 200 may include a large trained model that resides on a server (i.e., remote system 150) and is further configured with one or more single-task adapters 500, 500a-n that are trained based on fusion training data 720 (see FIG. 7).

The single-task adapters 500 may be used, together and in parallel, to adapt the ASR model 200 to multiple tasks. The ASR model 200 includes an audio encoder 210 pre-trained on an initial training data set and including a plurality of multi-head attention layers 400. For simplicity, the single-task adapters 500 include a first adapter 500a corresponding to a first task and a second adapter 500b corresponding to a second task. However, the single-task adapters 500 may include one adapter or three or more adapters each corresponding to a different task. As described in greater detail below, the pre-trained audio encoder 210 of the speech model 200 is adapted by inserting, in parallel, the first adapter 500a and the second adapter 500b at one or more of the multi-head attention layers 400 of the audio encoder 210. For example, the audio encoder 210 may include a base/backbone model that is trained on a large set of speech data. Once the audio encoder 210 is pre-trained, parameters of the audio encoder 210 may be frozen while the adapters 500 are trained for multi-task adaptation (knowledge composition). In other words, the adapters 500, which are each individually pre-trained for a particular single task, may be further fine-tuned to work together (i.e., outputs of each adapter 500 may be combined) such that the audio encoder 210 of the speech model 200 may be adapted/refined for multiple tasks without updating parameters/weights of the audio encoder 210. In some implementations, a plurality of fusion parameters 750 (see FIG. 7), which are not a part of any adapter 500, may be tuned or learned during training to learn how to combine the outputs of the adapters 500 for multiple tasks. In these implementations, the parameters of each adapter 500 may by frozen during tuning of the fusion parameters 750. In alternative implementations, parameters of the adapters 500 are also tuned during the knowledge composition stage. In this manner, the audio encoder 210 may be adapted for multiple-tasks using the adapters 500.

In some implementations, the adapters 500 are inserted at each multi-head attention layer 400 of the audio encoder. Each multi-head attention layer may include a Conformer layer, a Transformer layer, or other type of encoder layer implementing a multi-head attention mechanism. For simplicity, the present disclosure will refer to the multi-head attention layers 400 as Conformer layers. Here, the outputs of each adapter 500 may be aggregated together (and in some implementations aggregated with outputs of the corresponding multi-head attention layer 400) before being transmitted to the next layer 400 of the audio encoder 210 (e.g., a LayerNorm). The above implementations are exemplary only and are not intended to be limiting. The adapters 500 may be inserted at one or more suitable multi-head attention layers 400 of the audio encoder.

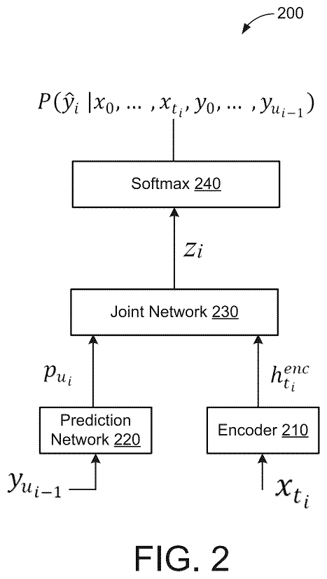

FIG. 2 is a schematic view of an example automatic speech recognition (ASR) model 200. In particular, the ASR model 200 of FIG. 2 includes an example frame alignment-based transducer model including a Recurrent Neural Network-Transducer (RNN-T) model architecture which adheres to latency constraints associated with interactive applications. The use of the RNN-T model architecture is exemplary, and the frame alignment-based transducer model 200 may include other architectures such as transformer-transducer and conformer-transducer model architectures among others. The RNN-T model 200 provides a small computational footprint and utilizes less memory requirements than conventional ASR architectures, making the RNN-T model architecture suitable for performing speech recognition entirely on the user device 102 (e.g., no communication with a remote server is required). The RNN-T model 200 includes an encoder network 210 (e.g., Conformer encoder 210), a prediction network 220, and a joint network 230. The encoder network 210, which is roughly analogous to an acoustic model (AM) in a traditional ASR system, includes a stack of self-attention layers (e.g., Conformer or Transformer layers) or a recurrent network of stacked Long Short-Term Memory (LSTM) layers. For instance, the encoder reads a sequence of d-dimensional feature vectors (e.g., acoustic frames 110 (FIG. 1) x=(x₁, x₂, . . . , x_{T}), where xₜ∈R_{d}, and produces at each output step a higher-order feature representation. This higher-order feature representation is denoted as h₁^{enc}, . . . , h_{T}^{enc}.

Similarly, the prediction network 220 is also an LSTM network, which, like a language model (LM), processes the sequence of non-blank symbols output by a final Softmax layer 240 so far, y₀, . . . , yᵤᵢ₋₁, into a dense representation pᵤ_{ᵢ}. Finally, with the RNN-T model architecture, the representations produced by the encoder and prediction/decoder networks 210, 220 are combined by the joint network 230. The prediction network 220 may be replaced by an embedding look-up table to improve latency by outputting looked-up sparse embeddings in lieu of processing dense representations. The joint network then predicts P (yᵢ|xₜ_{ᵢ}, y₀, . . . , yᵤ_{ᵢ₋₁}), which is a distribution over the next output symbol. Stated differently, the joint network 230 generates, at each output step (e.g., time step), a probability distribution over possible speech recognition hypotheses. Here, the “possible speech recognition hypotheses” correspond to a set of output labels each representing a symbol/character in a specified natural language. For example, when the natural language is English, the set of output labels may include twenty-seven (27) symbols, e.g., one label for each of the 26-letters in the English alphabet and one label designating a space. Accordingly, the joint network 230 may output a set of values indicative of the likelihood of occurrence of each of a predetermined set of output labels. This set of values may be a vector and may indicate a probability distribution over the set of output labels. In some cases, the output labels are graphemes (e.g., individual characters, and potentially punctuation and other symbols), but the set of output labels is not so limited. For example, the set of output labels may include wordpieces and/or entire words, in addition to or instead of graphemes. The output distribution of the joint network 230 may include a posterior probability value for each of the different output labels. Thus, if there are 100 different output labels representing different graphemes or other symbols, the output y; of the joint network 230 may include 100 different probability values, one for each output label. The probability distribution may then be used to select and assign scores to candidate orthographic elements (e.g., graphemes, wordpieces, and/or words) in a beam search process (e.g., by the Softmax layer 240) for determining the transcription 120.

The Softmax layer 240 may employ any technique to select the output label/symbol with the highest probability in the distribution as the next output symbol predicted by the RNN-T model 200 at the corresponding output step. In this manner, the RNN-T model 200 does not make a conditional independence assumption, rather the prediction of each symbol is conditioned not only on the acoustics but also on the sequence of labels output so far. The RNN-T model 200 does assume an output symbol is independent of future acoustic frames 110, which allows the RNN-T model to be employed in a streaming fashion.

In some examples, the encoder network (i.e., audio encoder) 210 of the RNN-T model 200 includes a stack of self-attention layers/blocks, each including a multi-head self-attention mechanism. Each self-attention layer may include a conformer layer/block. Here, each conformer block includes a series of multi-headed self-attention, depth wise convolution, and feed-forward layers. In some examples, the stack of conformer layers includes a stack of 24 layers having about 600 million parameters. In other examples, the stack of conformer layers includes a stack of 32 layers having about two billion parameters. The prediction network 220 may have two 2,048-dimensional LSTM layers, each of which is also followed by 640-dimensional projection layer. Alternatively, the prediction network 220 may include a stack of transformer or conformer blocks, or an embedding look-up table in lieu of LSTM layers. Finally, the joint network 230 may also have 640 hidden units. The Softmax layer 240 may be composed of a unified word piece or grapheme set that is generated using all unique word pieces or graphemes in a plurality of training data sets.

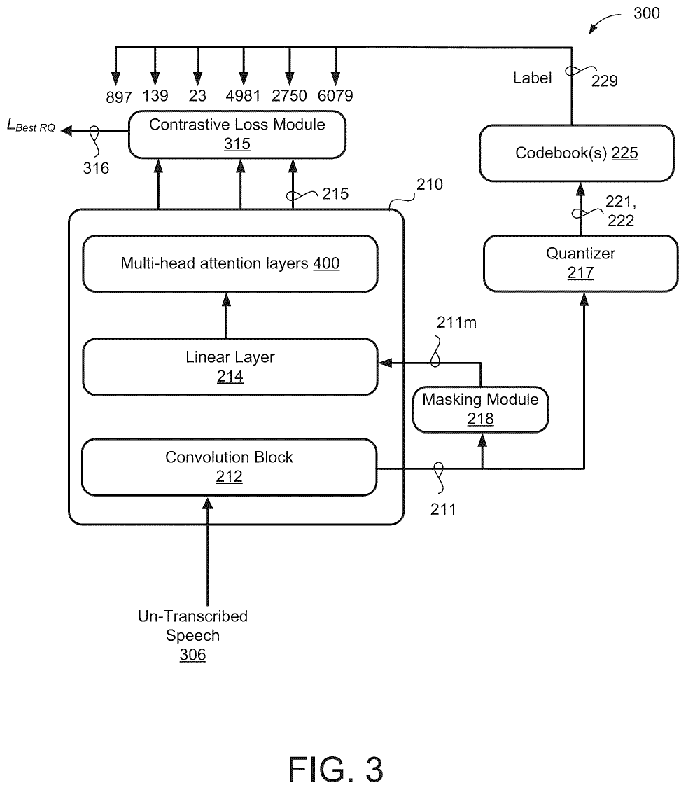

FIG. 3 illustrates an example training process 300 for pre-training the audio encoder 210. The training process 300 may pre-train the audio encoder 210 using available pre-training data that includes a set of un-transcribed speech utterances Xunsup 306. Each un-transcribed speech utterance Xunsup 306 includes audio-only data (i.e., unpaired data) such that the un-transcribed speech utterance 306 is not paired with any corresponding transcription. Further, the un-transcribed speech utterance Xunsup 306 may include only non-synthetic utterances (e.g., spoken by actual humans), which may be collected, for example, at the user device 102 of FIG. 1. The pre-training process 300 pre-trains the audio encoder 210 on the unsupervised/pre-training data that includes the un-transcribed speech utterances Xunsup 306. In the example shown, the pre-training process 300 employs BERT-based speech pre-training with random projection quantizer (BEST-RQ) for pre-training the audio encoder 210. BEST-RQ is described in “Self-supervised learning with random-projection quantizer for speech recognition,” see Proceedings of Machine Learning Research available at https://proceedings.mlr.press/v162/chiu22a.html. However, the pre-training process 300 may employ other training techniques.

In some implementations, the audio encoder 210 includes a Conformer encoder including a stack of conformer blocks each of which includes a series of multi-headed self attention, depth wise convolution, and feed-forward layers. Alternatively, the audio encoder 210 may include another type of encoder having a stack of self-attention layers/blocks, such as a transformer encoder. The Conformer encoder 210 can naturally be split into a feature encoder, including a convolution subsampling block 212, and a context network, including a linear layer 214 and a stack of Conformer blocks 400. The stack of Conformer blocks 400 may be interchangeably referred to as a “plurality of multi-head attention layers”). In some implementations, the convolution subsampling block 212 has two two-dimensional-convolution layers, both with strides (2, 2), resulting in a 4× reduction in the feature sequence length. The convolution subsampling block 212 receives, as input, a sequence of input features/vectors (e.g., mel-frequency spectrograms such as the acoustic frames 110 of FIG. 1) associated with each un-transcribed speech utterance 306, and generates, as output, for each of a plurality of output steps, an encoded audio feature 211 that corresponds to a respective one of the un-transcribed speech utterances 306.

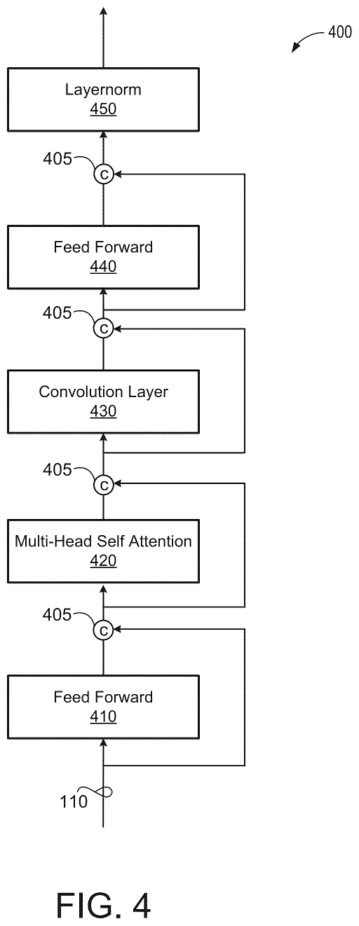

FIG. 4 illustrates an example Conformer block (i.e., multi-head attention layer) 400 for the encoder 210 of FIG. 3. The Conformer block 400 includes a first half feed-forward layer 410, a second half feed-forward layer 440, with a multi-head self-attention block 420 and a convolution layer 430 disposed between the first and second half feed-forward layers 410, 440, and concatenation operators 405. The first half feed-forward layer 410 processes the input acoustic frames 110 including the input Mel-spectrogram sequence. Subsequently, the multi-head self-attention block 420 receives the input acoustic frames 110 concatenated with the output of the first half-feed forward layer 410. The role of the multi-head self-attention block 420 is to summarize noise context separately for each input frame that is to be enhanced. A convolution layer 430 subsamples the output of the multi-head self-attention block 420 concatenated with the output of the first half feed forward layer 410. Thereafter, the second half-feed forward layer 440 receives a concatenation of the convolution layer 430 output and the multi-head self attention block 420. A LayerNorm module 450 processes the output from the second half feed-forward layer 440. Mathematically, the conformer block 400 transforms input features x, using modulation features m, to produce output features y, as follows:

$$\hat{x} = x + r ( m ) ⊙ x + h ( m ) \qquad ( 1 )$$

$$\tilde{x} = \hat{x} + \frac{1}{2} FFN ( \hat{x} ) , \tilde{n} = n + \frac{1}{2} FFN ( n ) \qquad ( 2 )$$

$${x}^{′} = \tilde{x} + Conv ( \tilde{x} ) , {n}^{′} = \tilde{n} + Conv ( \tilde{n} ) \qquad ( 3 )$$

$${x}^{′′} = {x}^{′} + MHCA ( {x}^{′} , {n}^{′} ) \qquad ( 4 )$$

$${x}^{′′′} = {x}^{′} ⊙ r ( {x}^{′′} ) + h ( {x}^{′′} ) \qquad ( 5 )$$

$${x}^{′′′′} = {x}^{′} + MHCA ( {x}^{′} , {x}^{′′′} ) \qquad ( 6 )$$

$$y = LayerNorm ( {x}^{′′′′} + \frac{1}{2} FFN ( {x}^{′′′′} ) ) \qquad ( 7 )$$

Referring back to FIG. 3, the encoded audio features 211 (i.e., interchangeably referred to as “encoded features 211”) output from the convolution subsampling block 212 may be fed to a masking module 218 where some of the encoded features 211 are randomly chosen and replaced with a trained feature vector shared between all masked time steps to provide corresponding masked encoded audio features 211m. In some examples, the masking module 218 masks the randomly chosen encoded features 211 for masking by randomly sampling without replacement a certain proportion p of all time steps to be start indices and then masks the subsequent M consecutive time steps from every sample index, whereby some spans may overlap. After masking is applied, the linear layer 214 and the Conformer blocks 400 of the context network receives the masked encoded features 211m (or encoded features 211 not chosen by the masking module 218) and outputs corresponding contrastive context vectors (i.e., encoded representation) 215 from masked encoded features 211m.

Moreover, a quantizer 217 receives the encoded features 211 as input, and applies random projections to generate, at each of the plurality of output steps, a target quantized vector token 221 and a target token index 222 for a corresponding encoded feature 211, 213 as output. As such, the quantizer 217 generates the target quantized vector token 221 and the target token index 222 using the encoded representations 211 that do not include any masking. Here, the quantizer 217 generates the target quantized

$${q}_{i} ∈ {\{ {e}_{j} \}}_{j = 1}^{V} .$$

The quantizer 217 summarizes all of the vector tokens 221 according to encoded features 211 into representative target quantized vector tokens (i.e., discriminative speech tokens) 221. The representative target quantized vector tokens 221 generated by the quantizer 217 represent a finite set of representative target quantized vector tokens referred to as a codebook 225. The target token index maps each corresponding encoded feature 211 to a respective one of the target quantized vector tokens 221 stored in the codebook 225. In some implementations, the quantizer 217 projects the target context vector 221 to a randomly initialized codebook 225 that maps the target context vectors 221 to discrete labels 229 by finding a nearest vector in the codebook 225. Notably, the quantizer 217 includes a random-projection quantizer 217 configured to randomly initialize a matrix and the codebook 225. The random-projection quantizer 217 uses the matrix to project the encoded features 211 into the target context vectors 221 and uses the codebook 225 to find a nearest vector where an index of the vector includes the label 229. In some examples, the codebook 225 finds the nearest vector by determining a cosine similarity as a distance measurement.

Thereafter, a contrastive loss module 315 derives a contrastive loss term (LBest RQ) 316 between the contrastive context vectors 215 at the masked positions and the target context vectors 221 as follows.

$$L = - log \frac{exp ( sim ( {c}_{t} , {q}_{t} ) / k )}{{\sum }_{\tilde{q} \sim {Q}_{t}} exp ( sim ( {c}_{t} , \tilde{q} ) / k )} \qquad ( 1 )$$

where cₜ is contrastive context vector 215 centered over a masked time step t and qₜ represents a target context vector 221 at the time step t in a set of K÷1 candidate target context vectors 221 which includes q and K distractors. Distractors may be uniformly sampled from other masked time steps of the same utterance. Advantageously, the contrastive loss 316 represents a Bidirectional Encoder Representations from Transformers (BERT)-based Speech pre-Training with Random Projection Quantizer (BEST-RQ) loss that does not require an additional quantization module that other contrastive losses (e.g., w2v-BERT) require. As such, since the BEST-RQ loss 316 does not require the additional quantization module, the BEST-RQ loss 316 enables the ASR model 200 to be more scalable for multiple languages during pre-training.

The contrastive loss (e.g, BEST-RQ loss) 316 is optimized between the contrastive context vectors 215 at the masked positions and the target context vectors 221. Accordingly, the semi-supervised part 300a of the training process 300a pre-trains the audio encoder 210 on the derived contrastive loss 316 applied on the corresponding encoded features 211 associated with each un-transcribed speech utterance 306 provided as input to the audio encoder 210. Pre-training the audio encoder 210 may include updating parameters of the audio encoder 210 based on the contrastive losses 316.

In some implementations, the pre-training process 300 uses one or more codebooks 225 instead of using a single codebook 225. For example, the contrastive loss part 300a may use sixteen (16) codebooks 225. More specifically, the audio encoder 210 generates N number of contrastive context vectors 215 (e.g., probability predictions output from the audio encoder 210) using a corresponding N number of softmax output layers for each encoded feature 211. This is in contrast to generating a single contrastive context vector 215 for each encoded feature 211 using a single codebook 225. To that end, the contrastive self-supervised loss part 300a randomly initializes N number of different codebooks 225 and, using each respective codebook 225 of the N number of codebooks 225, to finds a respective nearest vector where an index of the vector includes the corresponding label 229 of the respective codebook 225. By using multiple codebooks 225, the contrastive self-supervised loss part 300a compares N number of contrastive context vectors 215 to a corresponding N number of labels 229 for each encoded feature 211. Advantageously, using multiple codebooks 225 enables the contrastive self-supervised loss part 300a to improve stability and convergence of the audio encoder 210 during training. In some examples, the contrastive self-supervised loss part 300a trains the audio encoder 210 using equal weights for each Softmax layer output of the audio encoder 210.

The pre-training process 300 trains the audio encoder 210 to predict the labels 229 for each of the corresponding contrastive context vectors (i.e., encoded representation) 215 at the masked positions. Notably, both the randomly initialized matrix and the codebook(s) may be fixed during the pre-training part 300. After pre-training, the parameters of the pre-trained audio encoder 210 may be frozen. In turn, when adapting the audio encoder 210 using the adapters 500, only parameters of the adapters 500 (and/or fusion parameters 750) are adjusted during training, as discussed in greater detail below in connection with FIG. 7. Further, the adapters 500 may be inserted, in parallel, at the multi-head attention layers 400 when adapting the audio encoder. Additionally or alternatively, the adapters 500 may be inserted at any other layer 410, 420, 430, 440, 450.

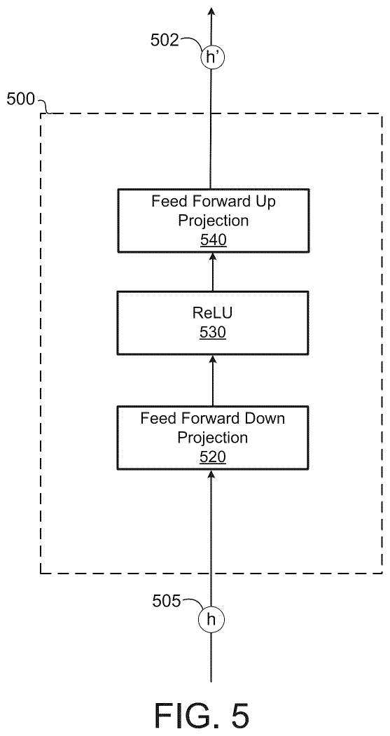

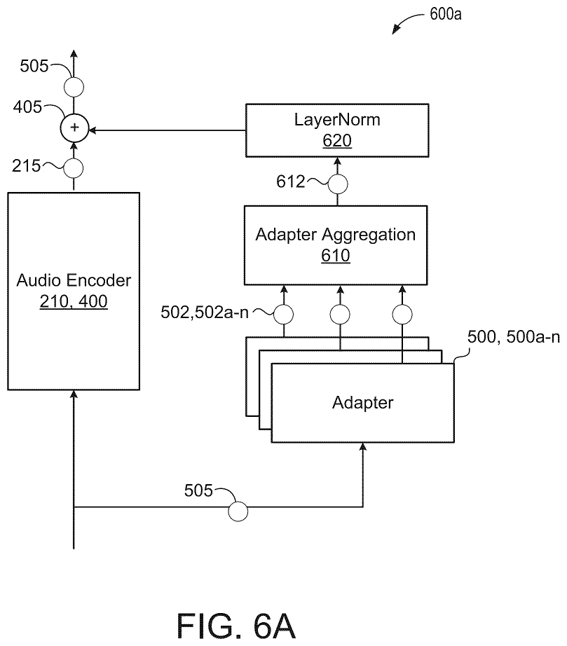

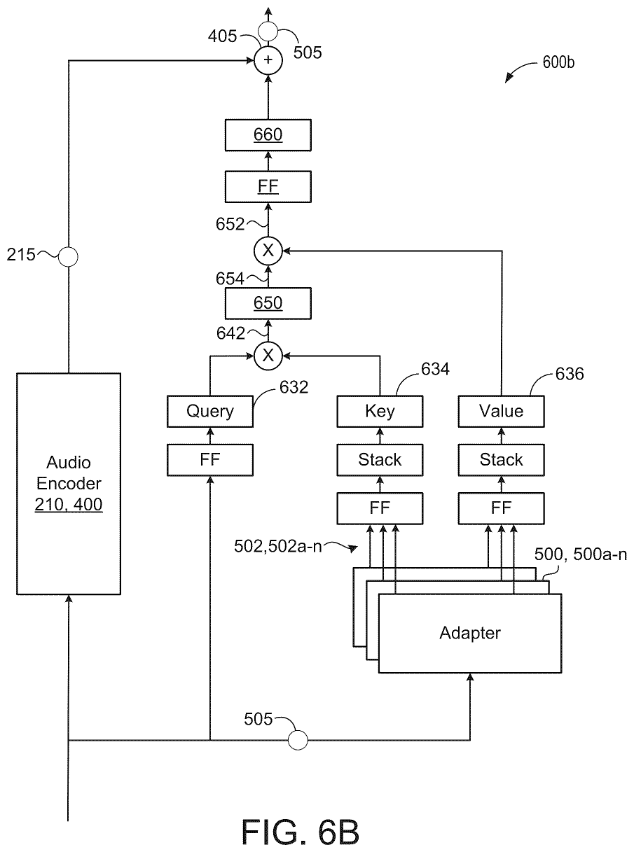

FIG. 5 illustrates an example adapter 500. The adapter 500 includes a down-projection layer 520, a Rectified Liner Unit (ReLU) layer 530, and/or an up-projection layer 540. In some implementations, the adapter 500 receives an input 505 (i.e., an output from a layer 400 of the audio encoder 210). The input 505 may include an encoded representation output by a previous multi-head attention layer 400 of the audio encoder. The adapter 500 then processes the input 505 through the layers 520, 530, and/or 540 to produce an output 502. In some implementations, the output 502 is a modified version of the input 505. The output 502 may then be aggregated with other outputs 502 from other adapters 500 that are inserted in parallel in the audio encoder, as discussed in greater detail below in connection with FIGS. 6A and 6B.

FIG. 6A is a schematic view 600a of an example A-AF architecture for the audio encoder. In this example, one or more single-task adapters 500, 500a-n are inserted in parallel at each multi-head attention layer 400 of the audio encoder 210. Each adapter 500 produces a corresponding output 502, 502a-n based on an input 505 (e.g., an output from a previous multi-head attention layer 400). Here, the input 505 corresponds to an encoded representation output by the previous layer of the audio encoder 210. In examples where the multi-head attention layer 400 corresponds to an initial multi-head attention layer 400, the input 505 may include a corresponding audio frame 110.

In the example shown, each adapter 500 is trained on a particular task. The outputs 502 are then aggregated by an adapter aggregation module 610. The adapter aggregation module 610 takes, as input, the outputs 502 of the multiple parallel adapters 500, and learns a representation that combines useful information from the outputs 502 of each adapter 500 into a projected weighted value 612. The projected weighted value 612 (i.e., aggregated outputs 502) is then passed through a LayerNorm 620 before being added to, or otherwise combined with, an encoded representation 215 output from the multi-head attention layer 210 via a residual layer 405 to provide an input 505 for the next multi-head attention layer and the one or more single-task adapters 500 inserted in parallel at the next multi-head attention layer.

The adapter aggregation module 610 may aggregate the outputs 502 of the adapters 500 using various methods, such as an adapter mean or an adapter-weighted mean. These adapter aggregation methods may be efficiently computed in matrix form using Einsum.

The adapter aggregation module 610 may compute an adapter mean Avg as a LayerNorm of an element-wise mean of the adapter outputs 502 at the multi-head attention layer l. Here, the Adapter Mean Avgₗ for layer/may be expressed as

$${A}_{l , t , i} = \frac{1}{N} {\sum }_{n = 1}^{N} {h}_{l , t , i , n} \qquad ( 8 )$$

$${Avg}_{l} = LayerNorm ( {A}_{l} ) \qquad ( 9 )$$

where h_{l,t,i,n} is the output 502 of the n^{th} adapter 500 at layer l∈{1, . . . , L}, time step t∈{1, . . . , T}, and hidden dimension i∈{1, . . . , d_{model}}. Notably, Avgₗ requires no added parameters and therefore no additional training.

The adapter aggregation module 610 may compute an adapter-weighted mean W Avg as a LayerNorm of a weighted element-wise mean of the adapter outputs 502 at Conformer encoder layer l, where weights W_{l,n}∀l∈{1, . . . , L}, n∈{1, . . . , N} are introduced in the second, knowledge composition stage (see FIG. 7) and trained to solve multiple tasks. Here, the Adapter Weighted Mean W Avgₗ for layer/may be expressed as

$${A}_{l , t , i} = \frac{{\sum }_{n = 1}^{N} {w}_{l , n} {h}_{l , t , i , n}}{{\sum }_{n = 1}^{N} {w}_{l , n}} \qquad ( 10 )$$

$$W {Avg}_{l} = LayerNorm ( {A}_{l} ) \qquad ( 11 )$$

where h_{l,t,i,n} is the output 502 of the n^{th} adapter 500 at layer l∈{1, . . . , L}, time step t∈{1, . . . , T}, and hidden dimension i∈{1, . . . , d_{mode}}.

FIG. 6B is a schematic view 600b of another example A-AF architecture for the audio encoder 210. The example A-AF architectures includes determining and combining a query 632, a key 634, and a value 636. Here, the query 632 is a projection of the input 505 of the frozen multi-head attention layer 400 of the audio encoder 210, and the key 634 and value 636 are projected and stacked outputs 502 of the parallel single-task adapters 500. In the illustrated example, a dot product 642 of the query 632 and the key 634 is passed through a Softmax function 650 to learn to weight features of each adapter 500, given an utterance. In some implementations, a set of fusion parameters 750 (see FIG. 7) are trained or learned to weight the outputs 502 of the adapters 500. The A-AF architecture determines a projected weighted value 652 by combining an output 654 of the Softmax function 650 with the value 636. The projected weighted value 652 is then passed through a LayerNorm 660 before being added to, or otherwise combined with, the output 215 of the multi-head attention layer 400 via a residual layer 405 to provide an input 505 for the next multi-head attention layer and the one or more single-task adapters 500 inserted in parallel at the next multi-head attention layer.

The A-AF architecture may aggregate the outputs 502 of the adapters 500 using various methods, such an A-AF metric. An example A-AF metric includes, given the input 505 to the adapters 500 at multi-head attention layer/and time step f, attending to different values of the hidden dimension of different task adapter outputs 502. Notably, the A-AF metric combines useful knowledge from each task to solve a particular utterance. In some implementations, the A-AF architecture computes an A-AF metric A-AF_{l,t} for layer l and time step t as follows. First, the query 632, key 634, and value 636 are projected to dimension d. The projection Q_{l,t} of the query 632 may be expressed as

$${Q}_{l , t} = {H}_{l , t} {W}_{l}^{Q} \qquad ( 12 )$$

where H_{l,t} is the stacked outputs at multi-head attention layer/and time step t, Wₗ^{Q} is the query weight matric at multi-head attention layer l, and H_{l,t} is formed from h_{l,t,i,n}, which are the outputs 502 of the n^{th} adapter 500 at layer l∈{1, . . . , L}, time step t∈{1, . . . , T}, and hidden dimension i∈{1, . . . , d_{model}}.

For each task adapter Φₙ 500 for n∈{1, . . . , N}, the A9AF architecture calculates a different key projection K_{l,t,n} and value projection V_{l,t,n} where W_{l,n}^{K} and W_{l,n}^{V} are the key and value weight matrices, respectively, at multi-head attention layer/and task adapter n. The key projection K_{l,t,n} and value projection V_{l,t,n} may be expressed as

$${K}_{l , t , n} = {Z}_{l , t , n} {W}_{l , n}^{K} \qquad ( 13 )$$

$${V}_{l , t , n} = {Z}_{l , t , n} {W}_{l , n}^{V} \qquad ( 14 )$$

The key and value projections for all the adapters 500 are then stacked in a new dimension, which may be expressed as

$${K}_{l , t} = Stack ( [ {K}_{l , t , o} , , {K}_{l , t , N} ] ) \qquad ( 15 )$$

$${V}_{l , t} = Stack ( [ {V}_{l , t , o} , , {V}_{l , t , N} ] ) \qquad ( 16 )$$

For each value of the projection dimension d, the probability distribution over the task-specific adapters 500 are multiplied with the value projection at dimension d, which may be expressed as

$${A}_{l , t , d} = Soft Max ( {Q}_{l , t} {K}_{l , t , d}^{T} ) {V}_{l , t , d} \qquad ( 17 )$$

Finally, the adapter attention matrix A_{l,t,d} is projected back to the adapter output dimension with W_{l,t}⁰, and a LayerNorm is used to compute the metric A-AF_{l,t} for layer l and time t as

$$A - {AF}_{l , t} = LayerNorm ( {A}_{l , t} , {W}_{l , t}^{0} ) \qquad ( 18 )$$

Here, the weight matrices Wₗ^{Q}∈ [symbol] ^{d}^{_{model}}^{×k}, Wₗ^{K}∈ [symbol] ^{d}^{_{model}}^{×N×k}, Wₗ^{V}∈ [symbol] ^{d}^{_{model}}^{×N×k}, Wₗ⁰∈ [symbol] ^{d}^{_{model}}^{×k}, and LayerNorm parameters are introduced in the second, knowledge composition stage and trained to solve multiple tasks where d_{model} is the adapter output dimension and k is the projection dimension. The metric A-AF_{l,t} may be efficiently computed in matrix form using Einsum.

FIG. 7 illustrates a fusion training process 700 for adapting a pre-trained audio encoder 210 to incorporate N single-task adapters Φₙ 500 for multi-task speech recognition. In some implementations, the fusion training process 700 employs a two-stage training technique. In a first, knowledge extraction stage, a backbone audio encoder Θ 710 and the N single-task adapters Φₙ 500 are pre-trained. Pre-training of the backbone audio encoder Θ 210 is discussed above in connection with FIG. 3. In some implementations, the audio encoder Θ 210 includes a Universal Speech Model (USM) including 2 billion parameters. In these implementations, the audio encoder Θ 210 may be pre-trained with the BEST-RQ objective on large unlabeled multilingual corpora of 12 million hours covering over 300 languages (not shown for clarity of illustration). Each adapter Φₙ 500 is pre-trained on their respective task (or domain) Dₙ using initial training data 715 corresponding to their respective task Dₙ. Thus, each adapter Φₙ 500 corresponds to a specific task, such as atypical speech, accented speech, etc. An adapter Φₙ 500 may be training using

$${Φ}_{n} {←}_{{Φ}_{n}} arg arg min ℒ ( {D}_{n} ; Θ ; {Φ}_{n} ) \qquad ( 19 )$$

where [symbol] ( ) may be, for example, an RNN transducer (RNN-T) loss function.

A second, knowledge composition stage of the two-stage training technique involves training the adapters Φₙ 500 on fusion training data 720, while parameters of the audio encoder Θ 210 are frozen. In some implementations, parameters of the adapters Φₙ 500 are also frozen while a set of fusion parameters Y 750 are learned or tuned during the second training stage. Here, the fusion parameters Y 750 are added to the multi-head attention layers 400 of the audio encoder 210. The result provides an audio encoder 210 that is adapted, by the adapters Φₙ 500, for multiple tasks. By separating the two training stages (i.e., knowledge extraction and knowledge composition) the fusion training process 700 addresses the potential issue of catastrophic interference between different tasks for conventional multitask ASR. The fusion parameters Ψ 750 may be trained using

$$Ψ {←}_{Ψ} arg min ℒ ( D ; Θ ; {Φ}_{1} , … , {Φ}_{N} ; Ψ ) \qquad ( 20 )$$

In some implementations, the fusion training process 700 may also train the adapters Φₙ 500 during the second stage using the fusion training data 720 to fine-tune the combined adapters Φₙ 500, while the parameters of the backbone audio encoder Θ 210 are frozen after pre-training. In some implementations, the fusion training data 720 is used to adapt the combination of the adapters Φₙ 500 such that, together, the adapters Φₙ 500 are configured for multiple tasks. In particular, ASR model 200 implementing the adapted audio encoder Θ 210 may generate a corresponding predicted output 760 (e.g., a predicted transcription or a probability distribution over possible speech recognition hypotheses) for a input training utterance 722, while only the parameters of the adapters Φₙ 500 are optimized (and/or the fusion parameters Ψ 750) based on a loss 772 determined by a loss function 770 based on the output 760 and a corresponding ground-truth label 724. In particular, the loss function 770 compares the output 760 and the label 724 to generate the loss 772, where the loss 772 indicates a discrepancy between the output 760 and the label 724 corresponding to the training input 722. The loss function 770 may implement any suitable technique to determine a loss such as regression loss, mean squared error, mean squared logarithmic error, mean absolute error, binary classification, binary cross entropy, hinge loss, multi-class loss, etc. In some implementations, the loss function 770 is an RNN-T loss function. The loss 772 may then be used to train the adapters 500 while parameters of the audio encoder 210 are held fixed. That is, the backbone audio encoder 210 is frozen and, thus, processing the loss 772 includes adjusting only one or more parameters of the adapters Φₙ 500 and/or the fusion parameters Ψ 750 to account for the loss 772.

In some implementations, the fusion training data 720 includes a plurality of spoken utterances 722 and corresponding ground-truth transcriptions 724 of the spoken utterances 722 (e.g., human-transcribed labels and/or machine-transcribed labels produced by teacher ASR model). The fusion training data 720 may include corresponding sequences of phonemes and graphemes. In some implementations, the training data set 720 is completely different from the initial pre-training data 715 used to train each adapter Φₙ 500 for a specific task.

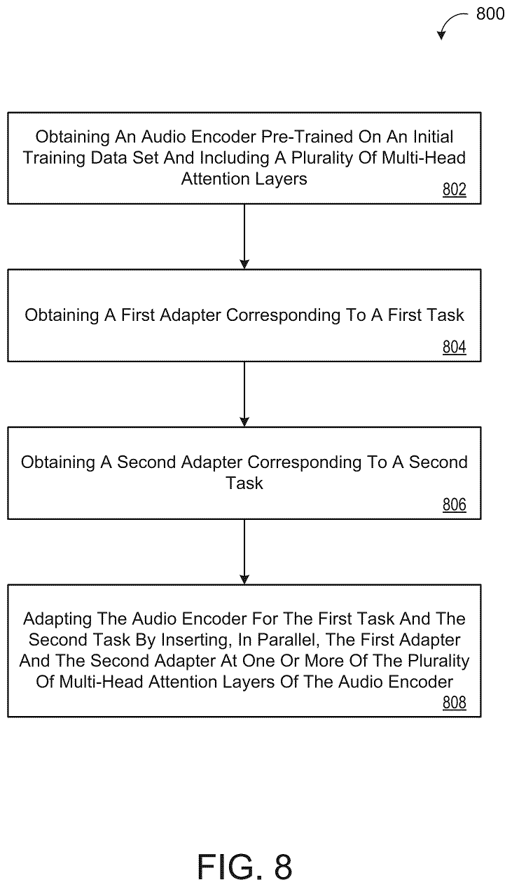

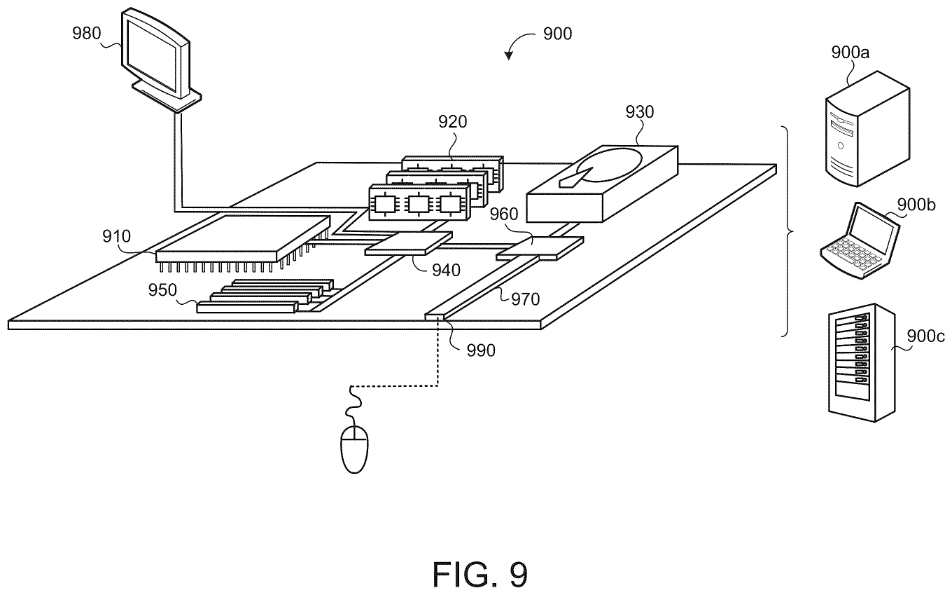

FIG. 8 is a flowchart of an exemplary arrangement of operations for a method 800 of A-AF for efficient and non-destructive multi-task speech recognition. The operations may be performed by data processing hardware 910 (see FIG. 9) (e.g., the data processing hardware 112 of the user device 102 or the data processing hardware 154 of the remote computing system 150) based on executing instructions stored on memory hardware 920 (FIG. 9) (e.g., the memory hardware 114 of the user device 102 or the memory hardware 156 of the remote computing system 150).

At operation 802, the method 800 includes obtaining an audio encoder 210 pre-trained on an initial training data set and including a plurality of multi-head attention layer 400. At operation 804, the method 800 includes obtaining a first adapter 500a corresponding to a first task. At operation 806, the method 800 includes obtaining a second adapter 500b corresponding to a second task. At operation 808, the method 800 includes adapting the audio encoder 210 for the first task and the second task by inserting, in parallel, the first adapter 500a and the second adapter 500b at one or more of the multi-head attention layers 400 of the ASR model 200.

FIG. 9 is a schematic view of an example computing device 900 that may be used to implement the systems and methods described in this document. The computing device 900 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 900 includes a processor 910 (i.e., data processing hardware) that can be used to implement the data processing hardware 112 and 154, memory 920 (i.e., memory hardware) that can be used to implement the memory hardware 114 and 156, a storage device 930 (i.e., memory hardware), a high-speed interface/controller 940 connecting to the memory 920 and high-speed expansion ports 950, and a low speed interface/controller 960 connecting to a low speed bus 970 and a storage device 930. Each of the components 910, 920, 930, 940, 950, and 960, are interconnected using various busses, and may be mounted on a common motherboard or in other manners as appropriate. The processor 910 can process instructions for execution within the computing device 900, including instructions stored in the memory 920 or on the storage device 930 to display graphical information for a graphical user interface (GUI) on an external input/output device, such as display 980 coupled to high speed interface 940. In other implementations, multiple processors and/or multiple buses may be used, as appropriate, along with multiple memories and types of memory. Also, multiple computing devices 900 may be connected, with each device providing portions of the necessary operations (e.g., as a server bank, a group of blade servers, or a multi-processor system).

The memory 920 stores information non-transitorily within the computing device 900. The memory 920 may be a computer-readable medium, a volatile memory unit(s), or non-volatile memory unit(s). The non-transitory memory 920 may be physical devices used to store programs (e.g., sequences of instructions) or data (e.g., program state information) on a temporary or permanent basis for use by the computing device 900. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 930 is capable of providing mass storage for the computing device 900. In some implementations, the storage device 930 is a computer-readable medium. In various different implementations, the storage device 930 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 920, the storage device 930, or memory on processor 910.

The high speed controller 940 manages bandwidth-intensive operations for the computing device 900, while the low speed controller 960 manages lower bandwidth-intensive operations. Such allocation of duties is exemplary only. In some implementations, the high-speed controller 940 is coupled to the memory 920, the display 980 (e.g., through a graphics processor or accelerator), and to the high-speed expansion ports 950, which may accept various expansion cards (not shown). In some implementations, the low-speed controller 960 is coupled to the storage device 930 and a low-speed expansion port 990. The low-speed expansion port 990, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 900 may be implemented in a number of different forms, as shown in the figure. For example, it may be implemented as a standard server 900a or multiple times in a group of such servers 900a, as a laptop computer 900b, or as part of a rack server system 900c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method executing on data processing hardware that causes the data processing hardware to perform operations comprising:
obtaining an audio encoder pre-trained on an initial training data set, the audio encoder comprising a plurality of multi-head attention layers;
obtaining a first adapter corresponding to a first task;
obtaining a second adapter corresponding to a second task; and
adapting the audio encoder for the first task and the second task by inserting, in parallel, the first adapter and the second adapter at one or more of the plurality of multi-head attention layers of the audio encoder.

2. The method of claim 1, wherein:
the first adapter is pre-trained on a first task training data set corresponding to the first task; and
the second adapter is pre-trained on a second task training data set corresponding to the second task.

3. The method of claim 2, wherein the operations further comprise:
obtaining a fusion training data set; and
training the first adapter and the second adapter based on the fusion training data set.

4. The method of claim 3, wherein training the first adapter and the second adapter based on the fusion training data set comprises tuning a plurality of fusion parameters added to the plurality of multi-head attention layers of the audio encoder.

5. The method of claim 4, wherein tuning the plurality of fusion parameters comprises:
obtaining a recurrent neural network-transducer (RNN-T) loss; and
tuning, based on the RNN-T loss, the plurality of fusion parameters.

6. The method of claim 4, wherein parameters of the first adapter and the second adapter are frozen while tuning the plurality of fusion parameters.

7. The method of claim 1, wherein the operations further comprise:
obtaining, based on an input, a first output from the first adapter;
obtaining, based on the input, a second output from the second adapter; and
aggregating the first output and the second output.

8. The method of claim 7, wherein the operations further comprise:
obtaining, based on the input, an encoded representation output from the audio encoder; and
combining the encoded representation with the aggregated first and second outputs.

9. The method of claim 1, wherein the initial training data set comprises a set of un-transcribed speech utterances.

10. The method of claim 9, wherein the audio encoder is pre-trained on the set of un-transcribed speech utterances using Bidirectional Encoder Representations from Transformers (BERT)-based speech pre-training with random projection quantizer (BEST-RQ).

11. The method of claim 1, wherein the plurality of multi-head attention layers of the audio encoder comprises a plurality of Conformer layers.

12. A system comprising:
data processing hardware; and
memory hardware in communication with the data processing hardware, the memory hardware storing instructions that when executed on the data processing hardware cause the data processing hardware to perform operations comprising:
obtaining an audio encoder pre-trained on an initial training data set, the audio encoder comprising a plurality of multi-head attention layers;
obtaining a first adapter corresponding to a first task;
obtaining a second adapter corresponding to a second task; and
adapting the audio encoder for the first task and the second task by inserting, in parallel, the first adapter and the second adapter at one or more of the plurality of multi-head attention layers of the audio encoder.

13. The system of claim 12, wherein:
the first adapter is pre-trained on a first task training data set corresponding to the first task; and
the second adapter is pre-trained on a second task training data set corresponding to the second task.

14. The system of claim 13, wherein the operations further comprise:
obtaining a fusion training data set; and
training the first adapter and the second adapter based on the fusion training data set.

15. The system of claim 14, wherein training the first adapter and the second adapter based on the fusion training data set comprises tuning a plurality of fusion parameters added to the plurality of multi-head attention layers of the audio encoder.

16. The system of claim 15, wherein tuning the plurality of fusion parameters comprises:
obtaining a recurrent neural network-transducer (RNN-T) loss; and
tuning, based on the RNN-T loss, the plurality of fusion parameters.

17. The system of claim 15, wherein parameters of the first adapter and the second adapter are frozen while tuning the plurality of fusion parameters.

18. The system of claim 12, wherein the operations further comprise:
obtaining, based on an input, a first output from the first adapter;
obtaining, based on the input, a second output from the second adapter; and
aggregating the first output and the second output.

19. The system of claim 18, wherein the operations further comprise:
obtaining, based on the input, an encoded representation output from the audio encoder; and
combining the encoded representation with the aggregated first and second outputs.

20. The system of claim 12, wherein the initial training data set comprises a set of un-transcribed speech utterances.

21. The system of claim 20, wherein the audio encoder is pre-trained on the set of un-transcribed speech utterances using Bidirectional Encoder Representations from Transformers (BERT)-based speech pre-training with random projection quantizer (BEST-RQ).

22. The system of claim 12, wherein the plurality of multi-head attention layers of the audio encoder comprises a plurality of Conformer layers
